(19) United States
(12) Patent Application Publication
(10) Pub. No.: US 2023/0158377 A1
(43) Pub. Date: May 25, 2023

(54) HEAD FITTING FILM FOR CLUB HEAD PROTECTION

(71) Applicant: Kyung Lee KWAK, Daegu (KR)

(72) Inventors: Sung Duk KIM, Gyeongsangbuk-do (KR); Chang Soo KIM, Daegu (KR)

(73) Assignee: Kyung Lee KWAK, Daegu (KR)

(21) Appl. No.: 17/921,100

(22) PCT Filed: Dec. 7, 2020
(86) PCT No.: PCT/KR2020/017756

§ 371 Date: Oct. 24, 2022

(30) Foreign Application Priority Data
Jan. 20, 2020 (KR) 10-2020-0007101

(51) Int. Cl. A63B 53/08; A63B 53/04

(52) U.S. Cl. CPC A63B 53/08; A63B 53/04; A63B 2053/0491; A63B 2209/10

(57) ABSTRACT

A head fitting film for club head protection includes: a protective film (10) attached to a surface of a club head and protecting the club head; an adhesive layer (20) formed on a side of the protective film (10); and a release paper (30) detachably attached to a bottom of the adhesive layer (20) and protecting an adhesive, wherein the protective film (10) is divided into multiple segments corresponding to an external shape of a club head such that the weight and a center of gravity of the club head are adjusted in accordance with the number of segments and attachment position of the protective film (10) that is attached to the club head.

### TECHNICAL FIELD

The present invention relates to a head fitting film for club head protection and, more particularly, to a head fitting film for club head protection, capable of preventing a club head from being scratched by being attached to the outer surface of a club head, and simultaneously adjusting the weight and a center of gravity of a club head for head fitting quickly, simply, and finely, thereby satisfying all of not only the athletic ability and taste of each user but also the convenience and economic efficiency in fitting work.

### BACKGROUND ART

The present invention relates to a head fitting film for club head protection and, more particularly, to a head fitting film for club head protection, capable of preventing a club head from being scratched by being attached to the outer surface of a club head, and simultaneously adjusting the weight and a center of gravity of a club head for head fitting quickly, simply, and finely, thereby satisfying all of not only the athletic ability and taste of each user but also the convenience and economic efficiency in fitting work.

### DISCLOSURE

### Technical Problem

In order to solve the defects described above in the related art, an object of the present invention is to provide a head fitting film for club head protection, capable of preventing a club head from being scratched or damaged by being attached to the outer surface of the club head.

Another object of the present invention is to provide a head fitting film for club head protection, capable of adjusting the weight and the center of gravity of a club head quickly, simply, and finely by being attached to the outer surface of the club head without machining the club head.

### Technical Solution

In order to achieve the objects, a head fitting film for club head protection of the present invention includes:

a protective film (10) attached to a surface of a club head and protecting the club head;

an adhesive layer (20) formed on a side of the protective film (10); and

a release paper (30) detachably attached to a bottom of the adhesive layer (20) and protecting an adhesive,

wherein the protective film (10) is divided into multiple segments corresponding to an external shape of a club head such that the weight and a center of gravity of the club head are adjusted in accordance with the number of segments and attachment position of the protective film (10) that is attached to the club head.

The protective film (10) further has a cut groove (101) formed at an edge thereof to be closely attached to a surface of the club head by adjusting the opening of the cut groove (101) when being attached to a surface of the club head.

The cut groove (101) has: straight portions (101a) formed at both sides to be connected to the opening; and

a curved portion (101b) connecting the straight portions (101a) at both sides inside the straight portions (101a).

The protective film (10) further includes a weight sheet (40) attached to an inner surface of the protective film (10) to adjust the weight and a center of gravity of a club head.

The weight sheets (40) in a plural number are stacked in multiple layers such that the amount of stacking and corresponding weight can be adjusted by selectively attaching and detaching the weight sheets (40).

A forming wire (50) is inserted along the edge of the protective film (10).

### ADVANTAGEOUS EFFECTS

According to the present invention, since the head fitting film for club head protection is closely and firmly attached to the outer surface of a club head in a bonding type, there is an effect that it is possible to prevent the club head from being scratched or damaged.

Further, since it is possible to adjust the weight and the center of gravity of the club head more quickly, simply, and finely by selectively attaching the weight sheet, there is an effect that it is possible to satisfy all of the athletic ability, taste, preference, feeling of hit, etc. of each user.

Further, since it is possible not only to reduce generation of a slice or a hook, but also to improve carry through effective fitting of weight and a center of gravity, there is an effect that the present invention helps to improve the ability of golf.

Further, since head fitting is quickly and simply performed, the convenience of head fitting is greatly improved and head fitting is possible at a low cost, there is an effect that economic efficiency is excellent.

### DESCRIPTION OF DRAWINGS

FIG. 1 is a perspective view according to an embodiment of a head fitting film for club head protection of the present invention.

FIG. 2 is a use state view according to an embodiment of a head fitting film for club head protection of the present invention.

FIG. 3 is a protective film perspective view according to a second embodiment of a head fitting film for club head protection of the present invention.

FIG. 4 is a protective film use state view according to the second embodiment of a head fitting film for club head protection of the present invention.

FIG. 5 is a use state cross-sectional view according to a third embodiment of a head fitting film for club head protection of the present invention.

FIG. 6 is a use state cross-sectional view according to a fourth embodiment of a head fitting film for club head protection of the present invention.

### BEST MODE FOR INVENTION

Hereinafter, embodiments of the present invention will be described in detail with reference to the accompanying drawings for those skilled in the art to be able to easily implement he present invention. However, the description of the present invention is only embodiments for structural or functional description, so the scope of right of the present invention should not be construed as being limited by the embodiments described herein. That is, embodiments may be changed and modified in various ways, so the scope of right of the present invention should be understood as including equivalents that can achieve the spirit of the present invention. Further, the objects or effects proposed herein do not mean that the objects or effects should be all included in a specific embodiment or only the effects should be included in a specific embodiment, so the scope of right of the present invention should not be construed as being limited by the objects or effects.

The terms used in the present invention should be understood as follows. The terms “first”, “second”, etc. are provided for discriminating one component from another component and the scope of right is not limited to the terms. For example, a first component may be named a second component, and vice versa. It will be understood that when an element is referred to as being “connected to” another element, it may be directly connected to the other element, but other intervening elements may be present. On the other hand, it will be understood that when an element is referred to as being “directly connected to” another element, other intervening elements are not present. Meanwhile, the term used herein to describe a relationship between elements, that is, “between”, “directly between”, “adjacent” or “directly adjacent” should be interpreted in the same manner as those described above.

The singular expressions should be understood as including plural expressions unless the context clearly indicates otherwise, and it will be further understood that the term “comprises” or “have” is intended to specify the presence of the stated features, numbers, steps, operations, elements, parts, or a combination thereof, but do not preclude the presence or addition of one or more other features, numerals, steps, operations, components, parts, or a combination thereof.

Unless otherwise defined, all terms used herein have the same meaning as commonly understood by those skilled in the art to which the present invention pertains. It will be further understood that the terms defined in dictionaries that are commonly used should be interpreted as having meanings that are consistent with their meanings in the context of the relevant art and will not be interpreted in an idealized or overly formal sense unless expressly so defined herein.

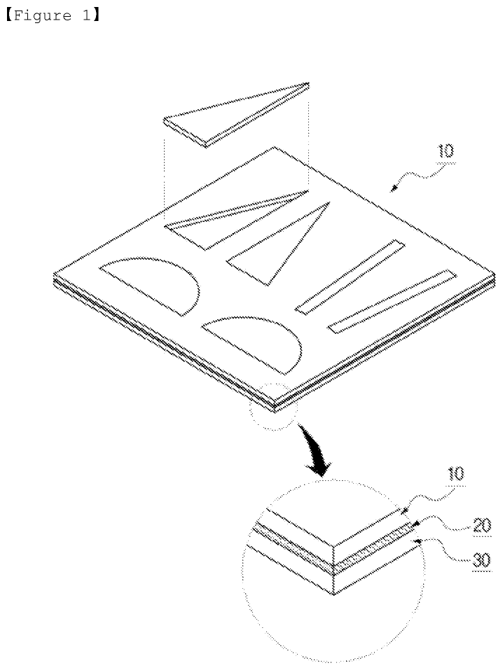

FIG. 1 is a perspective view according to an embodiment of a head fitting film for club head protection of the present invention, and FIG. 2 is a use state view according to an embodiment of a head fitting film for club head protection of the present invention.

The present invention is described with reference to FIGS. 1 to 2.

A head fitting film for club head protection of the present invention includes a protective film 10, an adhesive layer 20, and a release paper 30 to be able to prevent a club head from being scratched and simultaneously adjust the weight and the center of gravity of the club head for head fitting by being attached to the outer surface of the club head.

The protective film 10 is made of synthetic resin film having elasticity and a predetermined thickness to be able to protect a club head by being closely attached to the surface of a club head.

In this case, the protective film 10 may be attached to surround the entire of a club head or may be attached to surround a portion of a club head.

It would be preferable that the synthetic resin film, which is the main material of the protective film 10, is film made of synthetic resin such as polyester, polypropylene, polyvinyl chloride, and cellulose, and having a thickness of 1 mm or less and weight of 1 to 4 g, but it should be noted that the present invention is not limited thereto.

Accordingly, it is possible not only to more closely and firmly attach the protective film 10 to club heads formed with various curves, but also to prevent damage to a club head by absorbing impact, which is generated when a club head hits a golf ball, due to excellent elasticity of the protective film 10.

As another example, materials such as metal and carbon may be mixed with the material of the synthetic resin film when fabricating the protective film 10.

Accordingly, the wear resistance and durability of the protective film 10 are improved, and the weight is increased relative to a small thickness, thereby not only easily performing head fitting using the protective film 10, but also preventing the surface of a club head having the protective film (10) attached thereto from being scratched because the protective film has a characteristic of being strong against friction.

As another example, the synthetic resin film may be fabricated such that the glossiness is lustrous, semi-lustrous, and non-lustrous types when fabricating the protective film 10.

Further, the synthetic resin film may be fabricated such that the transparency is transparent, translucent, and opaque when fabricating the protective film 10.

Further, there is no doubt that the material of the synthetic resin film may be fabricated in various colors including color paints when fabricating the protective film 10.

Accordingly, it is possible decorate club heads in designs that users want using various glossiness, transparency, and colors, so it is possible to satisfy aesthetic tastes of users.

Meanwhile, the protective film 10 is divided into multiple segments corresponding to the external shapes of club heads.

Accordingly, the weight and center of gravity of a club head are adjusted in accordance with the number of segments and the position of the protective film 10 that is attached to the club head.

The adhesive layer 20 is formed on a side of the protective film 10, thereby

providing an adhesive force for closely attaching and fixing the protective film 10 to a club head.

It would be preferable, as a method of forming the adhesive layer 20 on a side of the protective film 10, to spray and apply an adhesive to a side of the protective film 10 in the process of fabricating the protective film 10, but the present invention is not limited thereto.

The release paper 30 can be detachably attached under the adhesive layer 20 and protects the adhesive layer 20, thereby preventing the adhesive layer 20 from being contaminated in the distribution process of the head fitting film for club head protection of the present invention, and when the protective film 10 is attached to a club head, the release film 30 is removed and then the adhesive layer 20 is directly bonded to the surface of the club head.

In this case, to easily remove the release film 30, it is preferable to further apply a lubricant or further form a lubrication coating layer on a side of the release film 30 that is supposed to be brought in direct contact with the adhesive layer 20, but it should be noted that the present invention is not limited thereto.

Meanwhile, the protective film 10 is divided into multiple segments corresponding to the external shapes of club heads.

That is, club heads are generally different in the shape, depending on the kinds of the clubs. For example, the club head of a driver that is used when hitting drive is composed of a face formed on the front of the club head to hit a golf ball, a crown formed on the top of the club head, a sole formed on the bottom of the club head, a tow formed on the outer surface of the club head, a heel formed on the inner surface of the club head, and a neck protruding upward from the inside of the club head to connect the club head and a shaft to each other, in which these parts are formed with different curvatures and shapes.

Accordingly, since it is technically very difficult to surround the entire of a club head with one sheet of protective film 10 formed to be flat, the protective film 10 is divided into multiple segments in accordance with the shapes of the parts of a club head, thereby more closely and firmly attaching the protective film 10 on the surfaces of club heads having various shapes and curves by selectively attaching the segments to the parts of the club heads, respectively.

Further, it is possible to increase the weight of a club head or adjust the center of gravity of a club head, depending on the attachment position of the protective film 10.

That is, when the protective film 10 is attached to the tow formed on the outer surface of a club head, the weight of the club head is increased and simultaneously the center of gravity is biased to the outside of the club head, and when the protective film 10 is attached to the heel formed on the inner surface of a club head, the weight of the club head is increased and simultaneously the center of gravity is biased to the inside of the club head.

Accordingly, the attachment position of the protective film 10 is adjusted in the process of head fitting for increasing weight by attaching the protective film 10 to a club head in accordance with a swing path that a user has taken to through repeated swings and a corresponding flying path of a golf ball, thereby reducing generation of a slice that is generated when a golf ball is hit with a club head open or a hook that is generated, reversely, when a golf ball is hit with a club head closed.

Further, when the protective film 10 is attached to the crown formed on the top of a club head, the weight of the club head is increased and simultaneously the center of gravity is moved upward in the club head, and when the protective film 10 is attached to the sole formed on the bottom of a club head, the weight of the club head is increased and simultaneously the center of gravity is moved downward in the club head, thereby reducing an excessive down blow or side blow.

As described above, the head fitting film for club head protection of the present invention is closely and firmly attached to the outer surface of a club head in a bonding type, thereby not only preventing the club head from being scratched or damaged, but also adjusting the weight and the center of gravity of the club head quickly, simply, and finely through selective attachment. Accordingly, there is an effect that it is possible to satisfy all of the athletic ability, taste, preference, feeling of hit, etc. of each user.

Further, since it is possible not only to reduce generation of a slice or a hook, but also to improve carry through effective fitting of weight and a center of gravity, there is an effect that the present invention helps improve the ability of golf.

Further, since head fitting is quickly and simply made, the convenience of head fitting is greatly improved and simultaneously head fitting is possible at a low cost, so there is an effect that economic efficiency is excellent.

Further, since the head fitting film for club head protection of the present invention can be easily fabricated in various sizes or designs, it can be produced as various kinds of products in accordance with the shapes of the club heads of various golf clubs such as a driver, a wood, an iron, and a putter, whereby there is an effect that it is possible to increase a commercial value by producing products corresponding to various golf clubs depending on users.

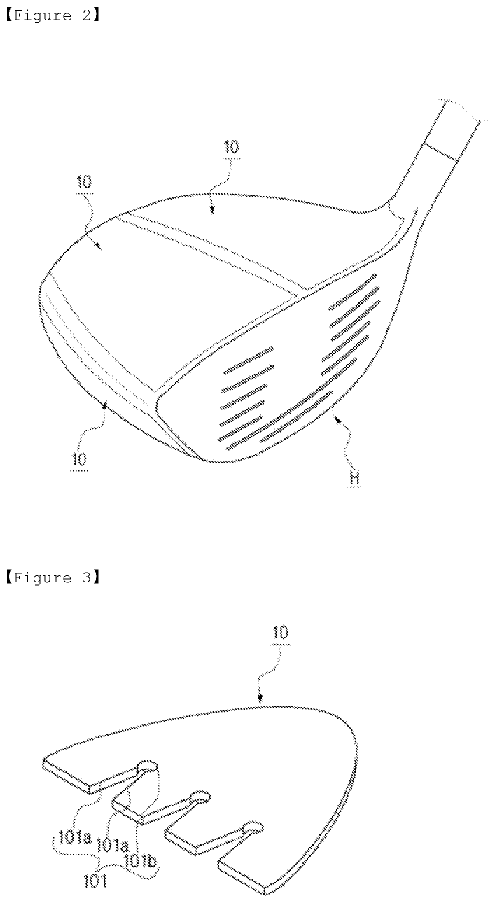

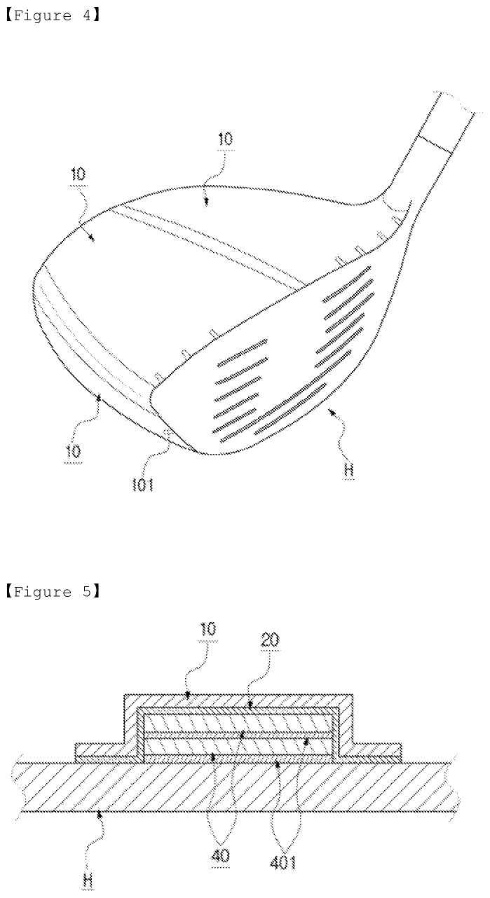

FIG. 3 is a protective film perspective view according to a second embodiment of a head fitting film for club head protection of the present invention, and FIG. 4 is a protective film use state view according to the second embodiment of a head fitting film for club head protection of the present invention.

A head fitting film for club head protection is described with reference to FIGS. 3 to 4, but a detailed description of components having repeated configuration and same reference numerals as the embodiment described above will be omitted.

The protective film 10 may further have a cut groove 101 at the edge.

That is, at least one or more cut grooves 101 are formed at the edge of the protective film 10, so the protective film 10 can be more closely attached to the surface of a club head by adjusting the opening of the cut grooves 101 along the curve of the surface of the club head in the process of attaching the protective film 10 to the surface of the club head.

The cut groove 101 has straight portions 101aand a curved portion 101b.

The straight portions 101aare formed at both sides of the cut groove 101 to be connected to the opening of the cut groove 101.

The curved portion 101bis formed to connect the straight portions 101aat both sides inside the straight portions 101a.

Accordingly, when the opening of the cut groove 101 is adjusted in accordance with the curve of the surface of a club head in the process of attaching the protective film 10 to the surface of the club head, it is possible to prevent the inside of the cut groove 101 from coming off even though the opening of the cut groove 101 is adjusted by the curved portion 101b.

FIG. 5 is a use state cross-sectional view according to a third embodiment of a head fitting film for club head protection of the present invention.

A head fitting film for club head protection is described with reference to FIG. 5, but a detailed description of components having repeated configuration and same reference numerals as the embodiment described above will be omitted.

The protective film 10 may further include a weight sheet 40.

It would be preferable that the weight sheet 40 is formed in a smaller size than the protective film 10 to have a thickness of 1 mm or less and weight of 1 to 4 g using a metal sheet, or a rubber sheet, an urethane sheet, or a carbon sheet mixed with metal powder and is attached to the inner surface of the protective film 10 so that the weight and center of gravity of a club head are more easily adjusted, but it should be noted that the present invention is not limited thereto.

Further, it is preferable that weight is printed or embossed or engraved on the surface of the weight sheet 40.

Accordingly, the weight sheet 40 has weight that makes it possible to easily adjust weight for head fitting using a size and a thickness smaller than those of the protective film 10, so it is possible to more easily and quickly perform head fitting by selectively attaching the weight sheet 40.

Further, the weight sheet 40 may be stacked in multiple layers.

In this case, it is preferable that a bonding layer 401 is further provided between the weight sheets 40 stacked in multiple layers.

Accordingly, the amount of stacking of the weight sheet 40 is adjusted by selectively attaching/detaching the weight sheet 40 stacked through the bonding layer 401 in head fitting, weight is more easily adjusted.

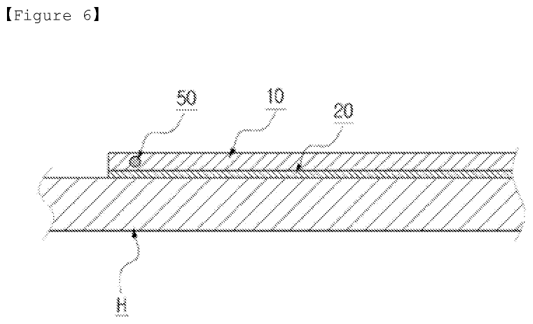

FIG. 6 is a use state cross-sectional view according to a fourth embodiment of a head fitting film for club head protection of the present invention.

A head fitting film for club head protection is described with reference to FIG. 6, but a detailed description of components having repeated configuration and same reference numerals as the embodiment described above will be omitted.

The protective film 10 may further include a forming wire 50.

The forming wire 50 is inserted along the edge of the protective film 10 and it is preferable that the forming wire 50 is made of a metallic material.

Accordingly, when the forming wire 50 is bent in accordance with the surface shape and the curvature of a club head in the process of attaching the protective film 10 to the surface of the club head, the edge of the protective film 10 in which the forming wire 50 is inserted is maintained in the shape bent by the forming wire 50 as the forming wire 50 is bent in accordance with the surface shape and the curvature of the club head, whereby the attached state of the protective film 10 that is attached to the surface of the club head is more firmly maintained.

Further, the forming wire 50 is made of a metallic material having strength higher than that of the protective film 10, whereby even if the protective film 10 is partially damaged due to contact between the ground and the club head having the protective film 10 attached thereto, direct contact of the ground with the club head is prevented by the forming wire 50 positioned on the surface of the club head, so it is possible to more effectively prevent the club head from being scratched or damaged.

Embodiments of the present invention are not implemented by only the devices and/or operation methods described above, and may be implemented through programs for achieving functions corresponding to the configuration of embodiments of the present invention, or recording media in which the programs are recorded, and the present invention may be easily achieved by those skilled in the art from the embodiments described above.

Although the embodiments of the present invention were described above in detail, the scope of right of the present invention is not limited thereto, and various changes and modifications by those skilled in the art using the basic concept of the present invention defined in the following claims are also included in the scope of right of the present invention.

1. A head fitting film for club head protection, the head fitting film comprising:
a protective film (10) attached to a surface of a club head and protecting the club head;
an adhesive layer (20) formed on a side of the protective film (10); and
a release paper (30) detachably attached to a bottom of the adhesive layer (20) and protecting an adhesive,
wherein the protective film (10) is divided into multiple segments corresponding to an external shape of a club head, and further has a cut groove (101) formed at an edge thereof to be closely attached to a surface of the club head by adjusting the opening of the cut groove (101) when being attached to a surface of the club head,
wherein the cut groove (101) has: straight portions (101a) formed at both sides to be connected with the opening; and a curved portion (101b) connecting the straight portions (101a) at both sides inside the straight portions (101a), and
the head fitting film further comprising:
a weight sheet (40) attached to an inner surface of the protective film (10) and adjusting weight and a center of gravity of a club head;
wherein the weight sheets (40) in a plural number are stacked in multiple layers such that the amount of stacking and corresponding weight can be adjusted by selectively attaching and detaching the weight sheets (40), and
a forming wire (50) inserted along the edge of the protective film (10) and bent in accordance with a surface shape and a curvature of a club head to enable the edge of the protective film (10) to be attached, so that the weight and a center of gravity of the club head are adjusted in accordance with the number of segments and attachment position of the protective film (10) that is attached to the club head.
